(19) United States
(12) Patent Application Publication
(10) Pub. No.: US 2003/0014332 A1
(43) Pub. Date: Jan. 16, 2003

(54) Automated locational asset inventory system

(76) Inventor: Glenn Gramling, McLean, VA (US)

Correspondence Address: John Leonarz, 6th Floor, C/o SETA 6862 Elm St., McLean, VA, 22101-3833, US

(21) Appl. No.: 09/902,779

(22) Filed: Jul. 12, 2001

(51) Int. Cl. G06F 17/60

(52) U.S. Cl. 705/28

(57) ABSTRACT

Improvements in asset management include method and apparatus for automated inventory in which an electronic inventory query module is resident on a telecommunications network, messages seeking an updated inventory are sent over the network to an electronic inventory agent having a unique, fixed geographic location code, the inventory agent responds with information identifying that location and all assets at that location, and the query module records the information for purposes such as display, archive, and comparison with previous inventories.

### CROSS REFERENCE TO RELATED APPLICATIONS

None

### STATEMENT REGARDING FEDERALLY SPONSORED R&D

No Federal funds were used in connection with this invention.

### SEQUENCE LISTINGS, COMPUTER PROGRAM LISTINGS

This invention does not involve either Sequence Listings or Computer Program Listings

### BACKGROUND OF INVENTION

1. Field of the Invention

The present invention relates broadly to asset management and telecommunications network systems. More particularly, the present invention relates to a device that has the ability to communicate with other devices through a telecommunications network, is physically located in close proximity to assets that are to be tracked, and has the ability to communicate with or otherwise determine the identity of said assets.

2. State of the Art

Asset management has always been an overlooked aspect of managing an enterprise. The general task of tracking assets is difficult, labor-intensive, and generally does not directly contribute to the goals of the enterprise. In addition, maintaining a complete and accurate inventory of assets requires strong policies and procedures and the discipline of all staff involved to follow the policies and procedures.

There have been many advances in the technologies associated with asset management. The most common technology advancements include asset tagging, which provides a machine-readable tag on an asset.. The most common version of asset tagging is the barcode, which is a tag made up of vertical lines arranged according to a code pattern. The vertical lines encode information about the asset. Barcode scanners can interpret the lines and identify the asset. A more sophisticated asset tagging technology is Radio Frequency Identification (RFID) tags, which encode information about the asset in electronic format. An RFID reader can decode all information on the RFID when it is in close proximity to the item.

Asset management advances are most notable in the area of telecommunications networks. Devices that are connected to a telecommunications network have a distinct advantage over other assets. Specifically, they are already communicating with other devices over the network. Therefore, as part of this communication, the device can also communicate its asset information to a centralized inventory repository. This eliminates much of the labor-intensity problem with asset management. Products have been developed to automatically collect configuration and inventory information for devices that are physically connected to a network and that could also be geographically dispersed.

With all the technological advances in asset management (including in the telecommunications arena), there is one piece of information that is not automatically captured, namely the location of the asset. The reason that this information cannot be automatically captured is simple: assets move. Because assets move, there is no reliable way for an asset to know its location. This is particularly true of ‘dumb’ assets, but is even true with devices that are ‘smart’, such as computers.

Because location information cannot, given the current state of the art, be automatically detected, a manual process is required. When an item is moved, the person moving the item ought manually note the location of an item. This information should then be entered into a centralized database. As items are moved from location to location, the staff member must update the centralized database with the new location.

The problem with this process is that it relies on personnel to perform some action to maintain the true location of all devices. This action must be completed on a regular basis. Once it has been determined that this action has not been performed each and every time, the location data is compromised and existing inventory records are rendered unreliable. The common solution to this problem is to have an audit of the data on a regular basis, requiring even more manpower to ensure the accurate tracking of the location of assets. Human errors in this process further degrade the validity of the data.

### SUMMARY OF THE INVENTION

It is therefore an object of the invention to provide a method and apparatus to track the location of assets without continual and regular human intervention.

In accord with the objects of the invention, an “Inventory Agent” is provided which (1) is able to communicate with a centralized repository over a telecommunications network, (2) is installed in such a way that its location relative to the network may be considered unchanging, (3) is located in close physical proximity to assets such that the location of the assets may be assumed to be the same as the Inventory Agent, (4) has the ability to determine which assets are within close proximity to the Inventory Agent, and (5) has the ability to respond to queries for the location of assets that are within close proximity to the Inventory Agent.

### BRIEF DESCRIPTION OF THE DRAWINGS

FIG. 1 is a general schematic drawing showing the relationship of an Inventory Query Agent to a communications network and an Inventory Agent.

FIG. 2 is a logical schematic drawing showing an Inventory Agent.

FIG. 3 is a flowchart schematic drawing showing the information flow through an Inventory Agent.

### DETAILED DESCRIPTION OF THE PREFERRED EMBODIMENT

Components of the Inventory Agent Configuration

Implementation of the Inventory Agent relies on several components (see FIG. 1). The process starts with an Inventory Query Agent, which is responsible for requesting location information about specific assets. The key attributes of the Inventory Query Agent typically are that it can (1) formulate a query to request location information for a specific asset, either scheduled or on an ad-hoc basis; (2) send the query out on a network to which it is connected, and (3) receive the response to the query. Although other platforms are available, the Inventory Query Agent is well suited to be implemented as a software program that runs on a computer server connected to a telecommunications network. The computer server provides a flexible platform on which the Inventory Query Agent can be implemented. Since computer servers are usually networked, sending queries and receiving responses is simplified. In addition, this implementation allows the Inventory Query Agent to integrate with computer asset management systems that collect other inventory-related information, such as hardware and software configurations.

The network can consist of many different topologies and technologies, including (but not limited to) local area networks (LANs), wide area networks (WANs), wireless or wired connectivity, Ethernet, Fast Ethernet, Gigabit Ethernet, and Token Ring. The only requirements for the network are that (1) it provides a communication path between the Inventory Query Agent and the Inventory Agent, and (2) it provides a method for routing query requests and responses between the Inventory Query Agent and the Inventory Agent.

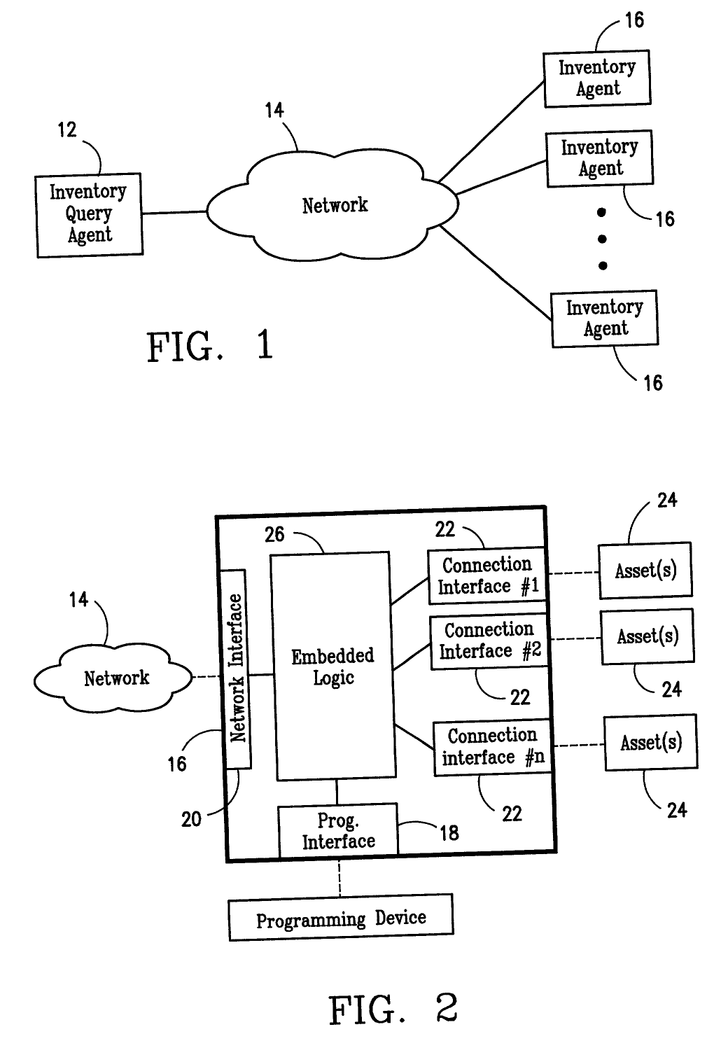

The Inventory Agent is a hardware device that is connected to the network. The Inventory Agent may actually be implemented as a face plate geographically fixed in an office or it may be some other device fixed nearby and at least virtually connected to the network at a position where it can monitor network traffic which may be directed to the network components in that office. The term Inventory Agent is used throughout this document without distinction as to whether the device is part of the faceplate or is otherwise positioned fixedly. The Inventory Agent has embedded logic that allows it to receive query requests sent from the Inventory Query Agent, determine if the request applies to an asset connected to the Inventory Agent, and send a response back to the Inventory Query Agent (see FIG. 2). The Inventory Agent has at least three interfaces. The first interface provides a method for programming the location code into the Inventory Agent. One such implementation of this is an EPROM interface. The second interface is the link to the network. This is implemented according to the needs of the selected network technologies and topologies. The remaining interfaces are used to communicate with connected assets. These interfaces may include a standard network connection so that networked devices (e.g., workstations, printers) may communicate with the network and the Inventory Agent over the same physical connection. Other such interfaces include methods for communicating with non-networked assets, such as, among other techniques, radio frequency identification (RFID) readers, which would allow the Inventory Agent to read RFID tags placed on assets.

Inventory Agent Setup

The inventory process requires that at least one Inventory Agent be installed on the network. One would wish to have several Inventory Agents installed if the collection of assets to be inventoried extended beyond close proximity to a single Inventory Agent. Each Inventory Agent is installed so that it can communicate with the network and with connected assets. Each Inventory Agent is programmed with a code that uniquely identifies its location from other the locations of other Inventory Agents on the network. The code is formulated so that asset locations can be deciphered (using lookup tables, hash algorithms, or other means) by the Inventory Query Agent into meaningful physical location data.

The Inventory Query Agent 12 is connected to the same network 14 so that it may send queries to and receive responses from the installed Inventory Agents 16.

The Inventory Agent Inventory Process

The inventory process starts when the Inventory Query Agent 12 formulates a query and sends it over the network 14. This event may be triggered manually by a person, may be scheduled to occur automatically on specific days and times, or may be triggered by other events (e.g., the location of a specific asset has not been verified for a set period of time). At a minimum, the query contains information regarding the target asset 24, e.g. the asset about which the Inventory Query Agent 12 seeks to receive location information.

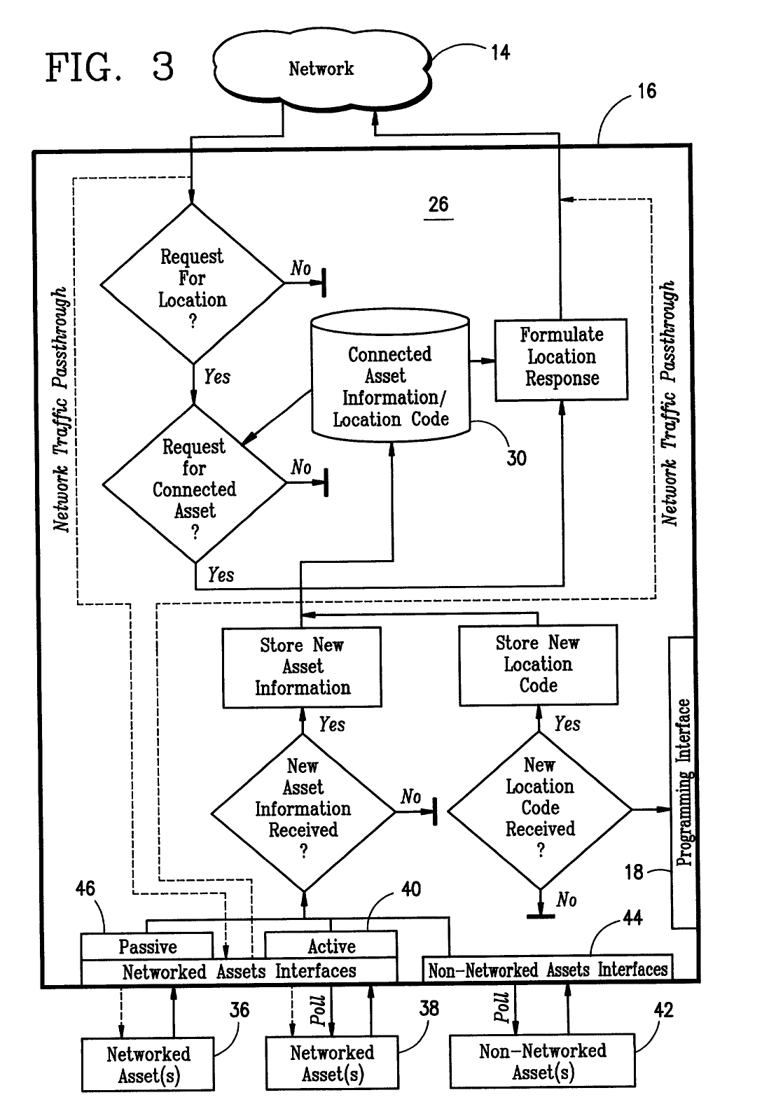

The query traverses the network 14 and reaches the Inventory Agent 16. The embedded logic 26 within the Inventory Agent 16 receives the query from the network 14 (see FIG. 3). It then compares the asset identifier information contained within the query with the list of assets in a database 30 that is connected to the Inventory Agent 16. If the target asset 24 is located in the list of connected assets in the database 30, the Inventory Agent 16 formulates a query response. At a minimum, the query response includes the target asset information (as provided in the query) and the location code (that is stored in the database 30) that was programmed into the Inventory Agent 16. The query response is sent over the network 14. (Note that if the target asset 24 is not located in the list of connected assets that is stored in the database 30, the Inventory Agent 16 simply ignores the query.)

The query response traverses the network 14 and is received by the Inventory Query Agent 12. The Inventory Query Agent 12 retrieves the target asset 24 information and the location code from the query response. This information is processed, which may include displaying the information on the screen, updating an inventory database, or triggering other events if the provided location code was unexpected.

Determining Connected Assets

One key aspect of the Inventory Agent inventory process is to determine which assets 24 are connected to the Inventory Agent 16. As described in the Components of the Inventory Agent Configuration section above, the Inventory Agent 16 consists of one or more interfaces 22 that are used to determine which assets 24 are connected. These interfaces 22 provide the identity of connected assets 24 to the embedded logic 26 so that it can respond to queries. These interfaces 22 fall into three categories, as described below.

Networked Assets (Passive) 36. An interface 46 in this category provides information about assets 36 that are already connected to and can communicate across the network 14. Examples of these assets 36 include computers and networked printers. In this category, the Inventory Agent 16 is an interface between the networked asset 36 and the network 14. As the networked asset 36 sends information through the Inventory Agent 16 to the network 14, the Inventory Agent 16 analyzes the information to determine and record the identity of the asset 36 sending the information. For this type of asset 36, the information sending process is typically repetitive over quite short intervals (seconds), so that special identification-seeking queries would be redundant. Therefore, the Inventory Agent 16 passively determines the identity of networked assets 36.

Networked Assets (Active) 38. An interface 40 in this category provides information about assets 38 that are already connected to and can communicate across the network 14. Examples of these assets 38 include computers and networked printers. In this category, the Inventory Agent 16 is an interface between the networked asset 38 and the network 14. The difference between interfaces 40 in this category and interfaces in Networked Assets (Passive) 36, described above, is that these interfaces 40 actively poll the connected networked assets 38. These interfaces 40 do not depend on the connected asset 38 to send information to the network 14 to determine that they are connected. This interface 40 would be used in cases where a networked asset 38 does not communicate frequently (e.g., at least every few minutes) over the network 14.

Non-Networked Assets 42. An interface 44 in this category provides information about assets 42 that are not already connected to the network 14 or do not have a native method for communicating with the network 14. Examples of these assets 42 include furniture, paintings, and computer equipment that is not connected to the network 14. Interfaces 44 in this category have a method for actively polling assets 42 that are connected to the interface 44 and receiving asset location (e.g., “there”/“not there”) information. In this context, a connection, typically a short-range connection of some kind intended to be effective for communication only in close proximity to the interface 42, may be established in any of a variety of ways, including, for example:

physical wiring having a means for reading and transmitting to the interface 44 a unique and meaningful asset identifier code firmly attached to the asset 42,

infrared signals emanating from a source fixed to the asset 42 and having codes in the signals which are readable by the interface 44 and which uniquely identify the asset 42,

radio signals emanating from a small, weak transmitter fixed to the asset 42 and carrying a unique asset identifier code readable by the interface 44, or other proximity sensing means.

Another example of such a means is Radio Frequency Identification (RFID). The interface 44 in this case is an RFI) reader. RFID tags are securely placed on assets 42. The interface 44 reads the asset information from the RFID tags for assets 42 that are in close proximity to the Inventory Agent 16.

1. Automatic inventory system comprising:
Inventory data collection logic means connected to a network,
Said inventory data collection logic means including means for sending query request messages over said network for requesting inventory information from devices connected to said network,
Resident logic means fixedly disposed on said network at at least one predetermined location, said predetermined location being identified by code which is effective to establish said predetermined location when received by said inventory data collection logic means,
Said resident logic means including means for sensing description data from items to be inventoried by said automatic inventory system, which said items are in close proximity to said resident logic means,
Said resident logic means being responsive to said query request messages for sensing said description data from said items currently in close proximity to said resident logic means and for transmitting said description data together with said predetermined location code, to said inventory data collection logic means for processing as inventory

2. The automatic inventory system of claim 1, wherein said resident logic means passes a signal to at least one active network component connected to said resident logic means to initiate a message containing said description data back to said resident logic means and said resident logic means includes means for adding its predetermined location code and means for transmission of both said description data and said predetermined location code to said inventory data collection logic means.

3. The automatic inventory system of claim 1, wherein said resident logic means includes sensing means for determining the current presence within a close proximity to said sensing means, of at least one specific item to be inventoried, and further including means for initiating a message containing description data for said specific item to be inventoried, and said resident logic means further including means for adding its said predetermined location code and means for transmission of both said description data and said predetermined location code to said inventory data collection logic means.

4. Method for automatic location inventory of an asset, comprising the steps of:
Applying to at least one asset to be inventoried, machine-readable identifying means,
Sending a query message over a telecommunications network to logic means at a predetermined fixed location, said logic means including a code uniquely identifying said predetermined fixed location for said logic means,
Receiving information indicating presence of said asset, at said logic means at said predetermined fixed location,
Associating said information indicating presence of said asset with said unique location identifying code,
Sending a message responsive to said query message over said telecommunications network incorporating, in association with each other, both said information indicating presence of said asset and said unique location identifying code, and
Collecting both said information indicating presence of said asset and said unique location identifying code from said response message into a database record for reporting said information as a location inventory.
